(19) United States
(12) Patent Application Publication
(10) Pub. No.: US 2005/0070167 A1
(43) Pub. Date: Mar. 31, 2005

(54) Indented female blow-molded connector

(76) Inventor: David J. Lipniarski, North Tonawanda, NY (US)

Correspondence Address: John M. Del Vecchio;Hodgson Russ LLP, Suite 2000, One M&T Plaza, Buffalo, NY, 14203-2391, US

(21) Appl. No.: 10/991,703

(22) Filed: Nov. 18, 2004

Related U.S. Application Data
(62) Division of application No. 10/314,672, filed on Dec. 9, 2002.

(51) Int. Cl. H01R 24/00

(52) U.S. Cl. 439/660

(57) ABSTRACT

A device and method for forming an indented female connector where the dimension of the indented female connector provides for removing a male molding component without damaging a set of internal ribs formed inside the female connector.

### BENEFIT CLAIM OF AN EARLIER FILED APPLICATION

This application is a divisional of patent application Ser. No. 10/314,672, filed Dec. 9, 2002, to Lipniarski for an Indented Female Blow-Molded Connector.

### FIELD OF INVENTION

The present invention relates generally to the molding of plastic parts, and specifically relates to a device for blow-molding a thermoplastic into the shape of an indented female connector.

### BACKGROUND OF THE INVENTION

Blow molding of plastics to form hollow shapes such as bottles, containers or the like is well known. Some shapes are difficult to mold into a hollow container with a blow molding process. An example of a shape that is difficult to mold is an indented female connector having a set of internal ribs for engaging with a male connector. Accordingly, there is a need for an improved device for molding an indented female connector as part of a hollow object.

### SUMMARY OF THE INVENTION

The present invention meets the above-described need by providing a male mold component that can be inserted into the mold to form the indented female connector in the container and that can be removed without damaging the ribs formed in the indented connector.

### BRIEF DESCRIPTION OF THE DRAWINGS

The invention is illustrated in the drawings in which like reference characters designate the same or similar parts throughout the figures of which:

FIG. 1 is a sectional side elevational view of the male mold component positioned inside a portion of the object to be molded;

FIG. 2 is a sectional side elevational view of the indented female connector; and,

FIG. 3 is a sectional side elevational view showing the mold component in broken lines as it is being removed from the indented female connector.

### DETAILED DESCRIPTION

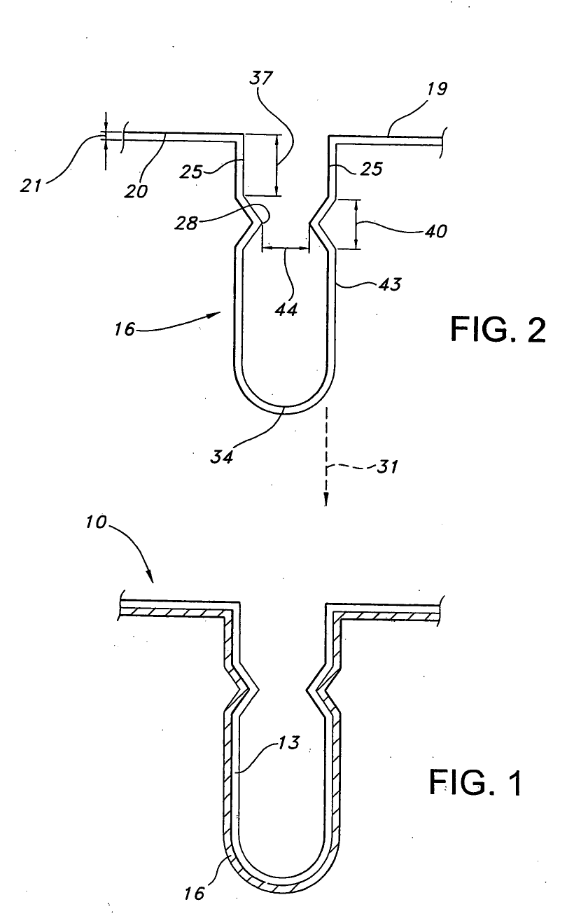

Referring generally to FIGS. 1-3 and initially to FIG. 1, a portion of a hollow molded object 10 is shown in a sectional side view. The portion shown is an indented female connector 16 that is formed in the side of the hollow object 10. The hollow object 10 is formed from thermoplastic materials by blow molding techniques known to those of ordinary skill in the art. A male mold component 13 is inserted into the mold to form the indented female connector 16 shown. Once the female connector 16 has been molded, the male mold component 13 is removed from the mold as described hereinafter.

Referring to FIG. 2, the indented female connector 16 is surrounded by a surface 19. The surface 19 is formed on an upper wall 20 having a thickness indicated at 21. The surface 19 is disposed substantially perpendicular to a set of inside walls 25 extending inward toward a rib 28 that is integrally formed in the inside walls during the molding process. Depending on the shape of the opening, the rib 28 may be formed on some or all of the inside walls 25. For a circular opening, the rib 28 may be formed in an annular configuration. For a rectangular opening the rib 28 may extend only along the opposed major lengths of the rectangle.

The rib 28 may extend from the inner wall inward at an angle of approximately forty-five degrees. As shown in FIG. 2, there is a pair of ribs 28 facing each other and extending inward at approximately a forty-five degree angle from an axis 31 parallel to the inside wall 25. With reference to the orientation of FIG. 2, the side walls 25 may continue downward and join by means of a section 34 disposed at the bottom of the connector 16. Although the section 34 is curved in the drawings, the section 34 may be formed in other shapes as well.

Between the top of surface 19 and the rib 28 is a flex section having a dimension 37. The distance along the rib is a locking surface 40, and the portion below the rib 28 is a receiving surface 43. The opening between opposed ribs 28 has a dimension 44 that will be discussed below.

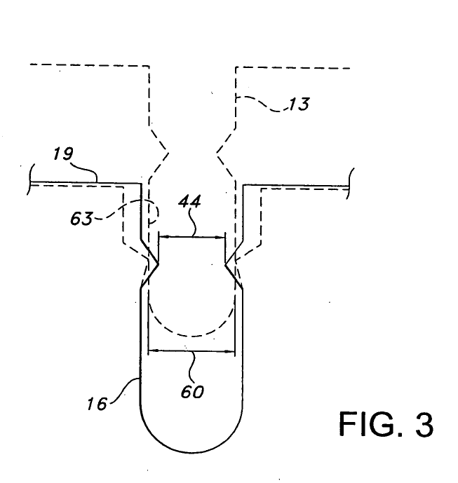

Turning to FIG. 3, after the blow molding process is completed, the male mold component 13 is removed from the indented female connector 16 by pulling it in a direction substantially perpendicular to top surface 19. The opening for removing the male mold component 13 is narrowest at the point between the ribs 28. This distance is also indicated in FIG. 2 as dimension 44. When the male mold component 13 is removed, the ribs 28 have to bend away from each other in order to accommodate the large diameter 60 of the lower portion 63 of the male mold component 13.

Returning to FIG. 2, it has been discovered that in order to form the ribs 28 and to successfully remove the male mold component 13 without damaging the ribs 28, a certain relationship between thickness 21 and the dimension 37 applies. If dimension 37 is greater than thickness 21, the mold 13 can be removed without damaging ribs 28. If dimension 37 is less than or equal to thickness 21, the ribs 28 are typically destroyed when the mold 13 is removed.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. A method of forming an indented female blow-molded connector, the method comprising:
providing a mold having two halves for forming an indented female connector having at least one inner wall extending substantially perpendicular to the first wall, at least one rib formed in the inner wall; a bottom wall connected to the inner wall; wherein a distance from the at least one rib to the top surface is greater than the thickness of the first wall;
providing a male mold component having a complementary shape to the female connector;
opening the mold;
injecting a balloon of material between the mold halves;
inserting the male mold component;
closing the mold;
forcing air into the balloon of material such that the material is pushed into mold cavities;
opening the mold; and,
removing the male mold component from the indented female connector.

2. The method of forming an indented female blow-molded connector according to claim 1 further comprising providing the at least one rib with an annular shape.

3. The method of forming an indented female blow-molded connector according to claim 1 further comprising providing the opening with a rectangular shape.

4. The method of forming an indented female blow-molded connector according to claim 1 further comprising providing the opening with a round shape.

5. The method of forming an indented female blow-molded connector according to claim 3 further comprising providing a pair of opposed ribs disposed on opposite sides of the rectangular opening.

6. The method of forming an indented female blow-molded connector according to claim 1 further comprising forming the at least one rib from a pair of walls converging at about a forty-five degree angle to one another.

7. The method of forming an indented female blow-molded connector according to claim 1 further comprising providing the bottom wall with a curvature.

8. A method of providing an indented female blow-molded connector, the method comprising:
providing a first wall with a top surface and a thickness and defining an opening in the first wall;
providing an inner wall and extending the inner wall in a direction substantially perpendicular to the first wall and bordering the opening;
providing a rib formed in the inner wall and providing the rib with a thickness equal to the thickness of the first wall and forming the rib from a pair of walls converging at an approximately forty-five degree angle relative to the inner wall;
providing a bottom wall joined to the inner wall; and
wherein a distance from the rib to the top surface is greater than the thickness of the first wall.

9. A method of providing an indented female blow-molded connector, the method comprising:
providing a first wall having a top surface and a thickness and providing an opening in the first wall;
providing at least one inner wall extending substantially perpendicular to the first wall and bordering the opening and providing the inner wall with a thickness;
forming at least one rib in the inner wall and the at least one rib having a rib thickness, the at least one rib extending inwardly;
forming a bottom wall having a bottom wall thickness and joining the bottom wall to the inner wall; and
wherein the distance from the rib to the top surface is greater than the thickness of the first wall and further wherein the thicknesses of the first wall, the at least one inner wall, and the at least one rib are the equal.

10. The method of providing an indented female blow-molded connector according to claim 9 further comprising forming the at least one rib from a pair of walls converging inwardly at an approximately forty-five degree angle relative to the inner wall.
